(19) United States
(12) Patent Application Publication
(10) Pub. No.: US 2002/0095420 A1
(43) Pub. Date: Jul. 18, 2002

(54) System and method of managing pre-paid electronic access to goods, services and other content

(76) Inventor: Benik Hovsepian, Beverly Hills, CA (US)

Correspondence Address: Attn: Spyros J. Lazaris, Esq., OPPENHEIMER WOLFF & DONNELLY LLP, Suite 3800, 2029 Century Park East, Los Angeles, CA, 90067, US

(21) Appl. No.: 10/054,361

(22) Filed: Jan. 17, 2002

Related U.S. Application Data
(60) Provisional application No. 60/261,789, filed on Jan. 17, 2001.

(51) Int. Cl. G06F 7/00

(52) U.S. Cl. 707/10

(57) ABSTRACT

A pre-paid electronic access system allows a consumer to access goods, services, and other content through specified, designated locations on a computer network, such as for example web sites. This system is provided for by the advance purchase of a certificate or card. Various hardware and software components manage the operation of the electronic access system. Consumers may also use the pre-paid access system to select and order content for separate delivery.

### CROSS-REFERENCE TO RELATED APPLICATIONS

The contents of this application are related to a provisional application having serial No. 60/261,789, filed on Jan. 17, 2001. The contents of this provisional application is incorporated herein by reference.

### BACKGROUND OF THE INVENTION

1. Field of the Invention:

The present invention relates to a system and method of providing and managing pre-paid electronic access to goods, services, and entertainment content. Specifically, the present invention relates to a pre-paid access certificate or card for accessing goods, services, and entertainment content through specified, designated sites on a computer network such as the Internet.

2. General Background and State of the Art:

The prior art contains many examples of pre-paid access services. One common example is a pre-paid card used to place long-distance telephone calls. Ubiquitous at establishments such as convenience stores and supermarkets, these cards allow users to purchase pre-set spending amounts and then dial a telephone number placed on the card to access their purchased time. Users then dial the telephone number of the person or entity they wish to call, and the pre-paid card is debited accordingly.

Other types of prior art pre-paid systems include gift certificate cards. Many retailers offer credit card-like systems with pre-paid amounts that users can later redeem at stores for any items they wish. These types of systems are activated at stores at the point of purchase of the card. The user then redeems the amount of the pre-paid card by selecting items and presenting the card the time of purchase of the items. The card is debited at the store until all of the pre-paid amounts are used.

Also ubiquitous in the art are offers for Internet access provided in conjunction with software embodied on a disc or CD. These offers provide an access code that allows a user, when installing the software, to obtain Internet access for a limited amount of time.

### INVENTION SUMMARY

A pre-paid electronic access system enables a person to receive, browse, order, and have delivered goods, services, and entertainment content through specified, designated locations on a computer network, such as for example web sites. This system is provided for by the advance purchase of a certificate or card. Various hardware and software components manage the operation of the electronic access system.

In one embodiment, the present invention provides a system for distributing access to various material on a network. The system includes a plurality of alphanumeric sequences each including a password component and a certificate identifier component. The system also includes hardware and software components, including a server, a database, and multiple system interfaces including an user interface and a management interface. The present invention also provides a method of distributing access to content over a computer network. The method includes providing a plurality of alphanumeric sequences, assigning a specified amount of time and a level of content access for each of the plurality of alphanumeric sequences, storing the alphanumeric sequences in a database, indicating to a consumer a choice of entering a personal credit card number or an alphanumeric sequence to obtain access to a level of content, authenticating an entered alphanumeric sequence by validating the entered alphanumeric sequence against the stored plurality of alphanumeric sequences in the database, placing the consumer in a menu field showing content accessible by the entered alphanumeric sequence, and allowing the consumer access the level of content authorized by the entered alphanumeric sequence.

In another embodiment, the present invention also provides a system for generating customized entertainment media. The system includes a database for storing content data and a plurality of alphanumeric sequences, and an user interface for allowing a consumer to present at least one of the plurality of alphanumeric sequences for accessing specific entertainment content on the computer network and select entertainment content. The system also includes a server for routing the selected entertainment content to a management interface, which generates media onto which selected entertainment content is transferred.

In still another embodiment, the present invention provides a method for generating customized entertainment media. The method includes providing entertainment content for customized selection by a consumer presenting a valid alphanumeric sequence, selecting entertainment content for order and delivery on a medium, storing the selected entertainment content on a server, verifying payment for the selected entertainment content, and generating and transmitting the medium to the consumer.

Accordingly, it is one object of the present invention to provide a system and method of distributing access to goods, services, and electronic content over a computer network.

It is a further object of the present invention to provide a system and method of ordering and delivering selected goods, services, and entertainment content to consumers.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a perspective view of a plurality of access certificates of the present invention positioned on a sales rack;

FIG. 2 is a front view of an access certificate showing a scratch-off section to reveal a component of an alphanumeric sequence;

FIG. 3 is a close-up view of a certificate showing a component of an alphanumeric sequence after scratch-off;

FIG. 4 is a front view of an access certificate wrapped in a package;

FIG. 5 a schematic diagram of the system components for the present invention;

FIG. 6 a flowchart of steps in a method of distributing access to content using the system of the present invention;

FIG. 7 is a general flowchart of a method of providing pre-paid content to consumers over a computer network;

FIG. 8 is a flowchart of a method of generating customized entertainment media;

FIG. 9 is a flowchart representation of another embodiment of the present invention, which provides a system and method of reducing fraud in electronic sales transactions;

FIG. 10 is a block diagram of a database system showing a plurality of tables storing information for generating customized media as in FIG. 8; and

FIG. 11 is a block diagram of a database system showing a plurality of tables storing information for the overall system of the present invention.

### DETAILED DESCRIPTION OF THE EMBODIMENTS

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

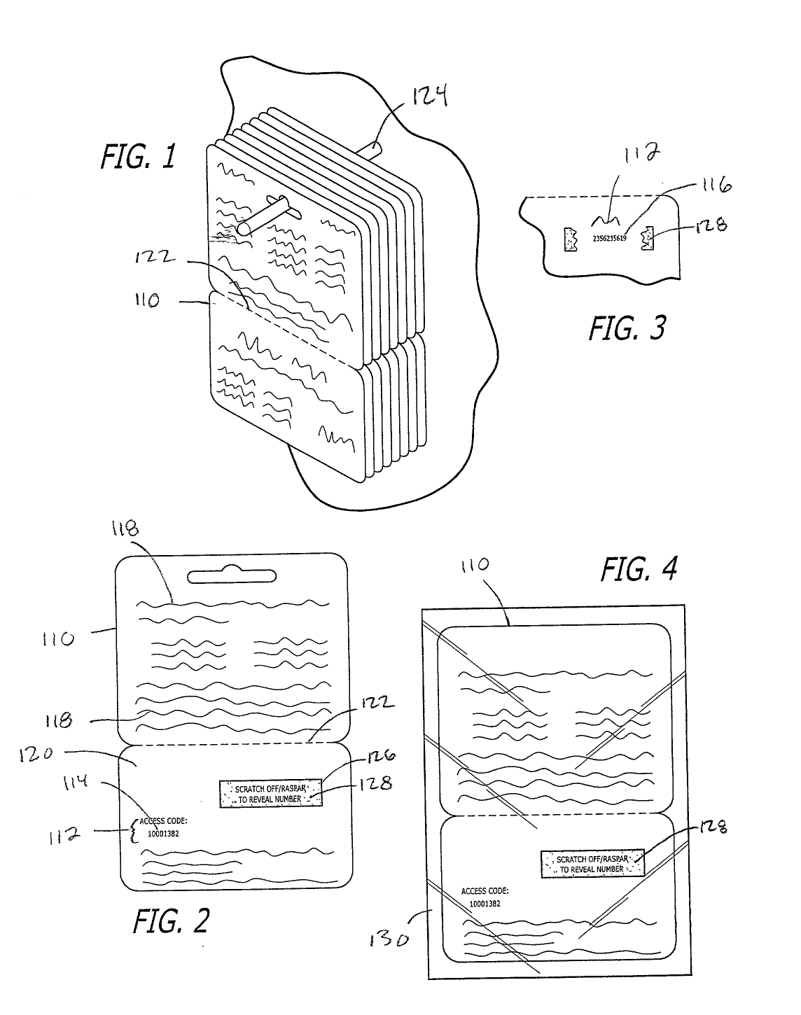

FIG. 1 is a perspective view of a plurality of access certificates 110 of the present invention. The access certificates 110 may be sold to consumers in stores as a card or electronically over a network. The terms certificate and card are used interchangeably when describing the present invention and its embodiments, but for simplicity, the term certificate will be used throughout this specification to mean either a certificate, card, or any other medium, virtual or physical. The certificates are provided for consumers to pre-pay for access to goods, services, and entertainment content over a computer network. Thus, using the present invention, consumer wishing to access goods, services, and entertainment content over a computer network may obtain pre-paid certificates or cards that provide access to any range of content. The content may be claimed at a specific location, such as a web site 150. The term “content” is intended to mean any materials, including but not limited to goods, products, services, media, which may be purchased, viewed, browsed or ordered using a network.

The certificates may each include an alphanumeric sequence 112 composed of different components. One such component, a certificate identifier 114, is used by system hardware and software to identify certificates that have been issued for redemption of particular products. Another component, a password 116, is also used to track issuance and redemption of the certificates. Together, the certificate identifier 114 and the password 116 serve as a security method for preventing the unauthorized use of the certificates.

The certificates 110 may also include several areas of indicia 118 to indicate such things as instructions, locations (or web sites 150) where certificates can be redeemed, price, and menu selections of goods, services, and content that come with certificates. FIG. 2 shows a close-up view of a front face 120 of an access certificate 110. As shown in FIG. 2, the certificates 110 may also have lines of separation 122 along which certificates can be removed from additional portions. Certificates having a line of separation are fold-over certificates allowing the certificate owner to either place the certificate in his or her wallet or purse in the same manner as a credit card, or with the lines of separation, to be removed from the additional portion and held in a device such as a Rolodex. The certificates 110 may also have holes positioned on the additional portions for hanging on a rack 124 in a store, as shown in FIG. 1, or holes positioned on the certificate portion itself for placement in a Rolodex. Those access certificates in a physical embodiment, as shown in FIG. 1, may be in any shape or size and be made of any suitable material, including but not limited to paper, plastic, cardboard or metal.

FIG. 2 also shows an area 126 of the access certificate 110 in which a scratch-off portion 128 conceals the password 116 needed to redeem the certificate for the product it represents. In this embodiment, a consumer purchases the certificate from a vendor and then removes the scratch-off portion to reveal the password 116. FIG. 3 shows a close-up view of an access certificate having its scratch-off portion 128 removed to reveal a password 116.

FIG. 4 shows an access certificate 110 disposed in a package 130 as it would appear if sold in a store. The package 130 is intended to prevent consumers from scratching off the scratch-off portion 128 prior to purchase of the certificate, to prevent theft of the product represented by the certificate.

The issuance, management and control of the access certificates 110 is controlled by an overall system that uses several components to generate and manage certificates that can be reclaimed for some product, for example accessing specified entertainment content. The term certificate, or card, loosely refers to a method of distributing alphanumeric sequences, or identification pairs, having at least a certificate identifier component and a password component. These sequences are used to authenticate activated certificates, thus authorizing the consumer to obtain whatever product the certificate represents. Certificates 110 may be embodied on any conceivable medium, such as printed on a tangible item or distributed through electronic media, such as electronic mail. Each activated alphanumeric sequence 112 can be reclaimed only once.

The life cycle of a certificate 110 representing pre-purchased product for reclamation includes several stages. Alphanumeric sequences 112 are created and assigned a product. The value of each certificate 110 is determined by the value of the product assigned to it at the time it is issued.

Once the alphanumeric sequences 112 have been created, certificates 110 can be issued to vendors for distribution to consumers. The certificates 110 are activated at this time, thereby permitting use by the end consumer. An invoice may be generated to the vendor charging it the value of each certificate at a discount rate. For example, if the vendor is issued a certificate whose product is worth $100, and the vendor's discount rate is 90%, the vendor is invoiced for $90. A record for each certificate that has been issued is updated to indicate which vendor it has been issued to, the date it was issued, and the employee that issued the certificate.

A consumer then purchases the certificate 110 from the vendor. The price paid for the certificate by the consumer is regardless of the current value of the product represented by the certificate. The next step in the process is certificate reclamation. The consumer reclaims the certificate for whatever product is it represents by entering the alphanumeric sequence 112 associated with the certificate on an user interface. The alphanumeric sequence 112 is validated against the list of activated certificates. If the entered alphanumeric sequence 112 does not match any alphanumeric sequences in the list of activated sequences, it is invalidated. If it does match, the certificate is validated, and the record of the certificate is updated to indicate that it has been reclaimed. Once fully reclaimed, the certificate is then removed from the list of activated certificates, preventing it from being reclaimed by anyone else.

The system of the present invention includes, as discussed above, a certificate 110 which includes the alphanumeric sequence 112 that, when authenticated, provides access to specified entertainment content. The certificate 110 must include the alphanumeric sequence 112, which has at least two specific pieces of information the certificate identifier 114 and the password 116. In one embodiment, physical cards 110 may be printed with the certificate identifier and password printed on the card. The card may include a scratch-off section 128 where the password is reveal to the consumer after purchasing the card by scratching off the portion hiding the password. Physical cards may be issued as part of a receipt of an invoice, or any other tangible medium. In another embodiment, the certificate may be virtual, as in the form of an electronic file or certificate. Virtual certificates may be in any form that does not require physical printing, such as by electronic data, for example in an electronic mail or on a web page.

The certificate identifier component 114 of an alphanumeric sequence 112 is any string or collection of characters that uniquely identifies a certificate. The password component 116 is any otherwise meaningless string or collection of characters that has been assigned to a certificate identifier to be used to validate an alphanumeric sequence 112. This string can be represented by several methods, depending on implementation.

In one embodiment on the present invention, a consumer may purchase an electronic access certificate and, if the access certificate specifies a location on a network where the monetary value represented by the certificate can be redeemed, visit that location. The consumer enters the accompanying alphanumeric sequence at a user interface while visiting the location, and is then provided with access to purchase, view, browse, select, and order whatever content he or she is able to access with the certificate. This may be in the form of general goods and services, or specialized content, such as entertainment content. The term content therefore refers to any materials able to be accessed with the access certificate.

The access certificate 110 and its associated software allow for sales in any currency worldwide, in any country, which would permit the retail sale and distribution thereof. The calculations of access time credits and number of entertainment forums are determined and based on the United States dollar. The software calculates and authorizes access to consumers from anywhere in the world based on any currency. Therefore the consumer may also be provided with a choice of monetary ranges of certificates to purchase in United States Dollars, Canadian Dollars, Swiss Francs, and so on. The purchased certificate is a non-rechargeable certificate and upon the expiration of the specified period of access time, and will no longer provide for access to the specified web Site upon the expiration of that time period.

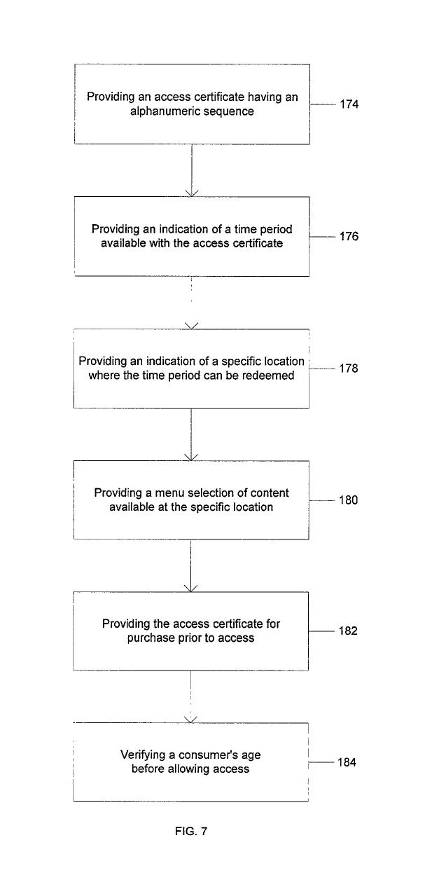

The software also provides an age verification mechanism for access to content which requires consumers to be of a certain age. This is shown in block 184 of FIG. 7. The age verification aspect of the system is used when a consumer attempts to access content that is restricted by age. The system prompts the consumer to enter a birth date, which the system then calculates to determine the consumer's age. Alternatively, the system may simply prompt the consumer for his or her age. If the age is above the minimum required age, the system then allows the consumer to continue accessing specified menu selections of entertainment. If the system determines the consumer's age to be below the minimum required age, the system blocks the consumer from accessing the restricted content.

The system that manages the creation of and monitors the use of the alphanumeric sequences 112 also includes software to enable the consumer to access the specified web site(s) 150. In order to accommodate multiple access requirements, the software is capable of accepting and processing millions of access requests simultaneously to the specified web site(s) 150. Upon accessing the specified web site(s) indicated on the access certificates, the software provides a prompt signal indicating to the consumer the choice of entering the web site either through the use of a personal credit card or by use of the pre-paid access certificate. By selecting the entry method of the pre-paid access certificate, the consumer is prompted to the enter the alphanumeric sequence 112 shown on the certificate and containing the certificate identifier 114 and the password 116.

Upon entry of the alphanumeric sequence, the software program accepts and authenticates the validity of the alphanumeric sequence against its stored database which contains a list of all issued alphanumeric sequences. The software authenticates the entered sequence, and, if authentic, automatically places the consumer into a menu field showing the various entertainment forums accessible by the certificate. The software program automatically provides the consumer with a menu of entertainment forums available based upon the monetary value of each pre-paid certificate.

The alphanumeric sequences created by the software program are stored in the database awaiting activation by a consumer. The software program never duplicates the alphanumeric sequences. As the pre-paid access certificates are designed to be sold in multiples of monetary values around the world, the software program provides automatic correlation between the alphanumeric sequences and the access to the designed number of entertainment forums in terms of time access credits.

Upon entry into the specified entertainment menu forum, the software program commences calculation of the remaining time. credits that is stored for each authentication number and continually monitors its access use as the entertainment service that is provided. This process is referred to as real time countdown. Upon the consumer exiting a specified web site, the program will maintain the period of time accessed and automatically establish a new access time period remaining for that particular certificate. As the consumer continues to access the specified web site(s), the program continues to monitor the remaining access time credit until the expiration of that particular certificate containing the specified alphanumeric sequence. The software program is designed to specifically prohibit re-activation or re-charge of the alphanumeric sequences and upon the expiration of the access time credit, is designed to prohibit access to the specified web site(s).

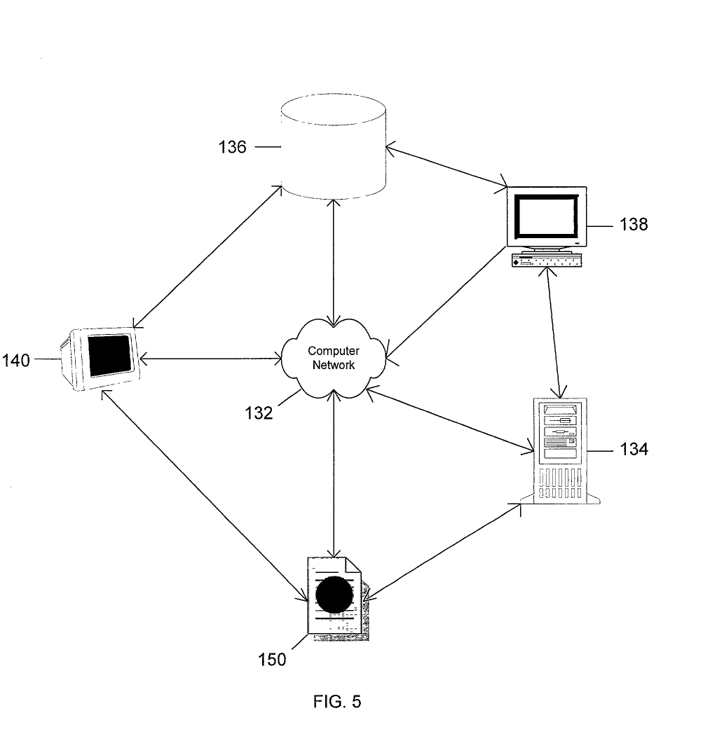

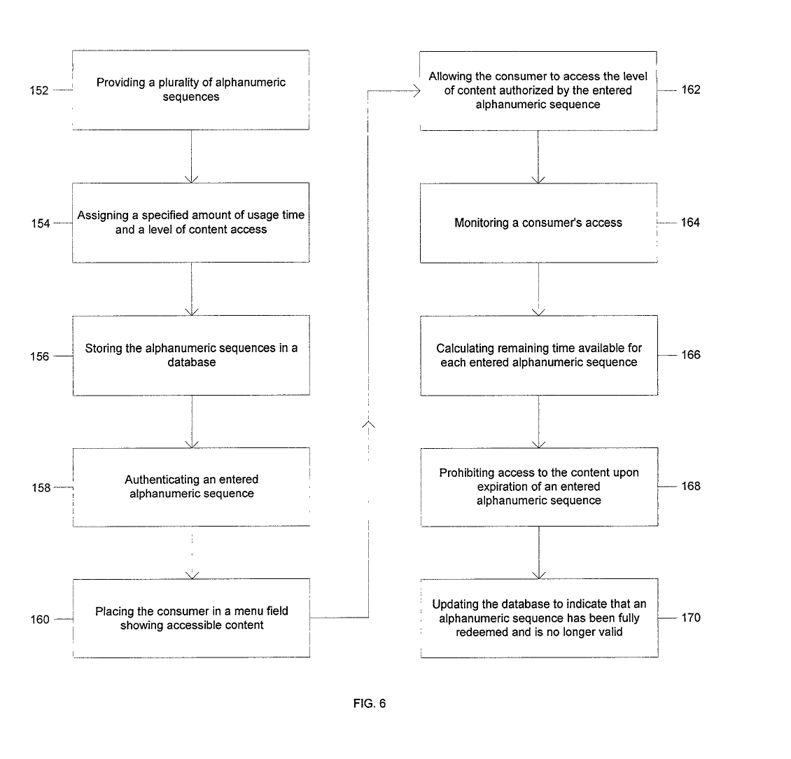

FIG. 5 is a schematic diagram of the system components behind certificate issuance and redemption. The system comprises a computer network 132, which includes a server 134, a database 136, the physical and/or virtual certificates 110, and multiple network interfaces, including a management interface 138 and a user interface 140. The computer network 132 used may be any network of computers communicating with one another over a wide or local area. One example of a computer network used in conjunction with the present invention is the Internet.

FIG. 11 is a block diagram of a database system showing a plurality of tables storing information needed for operating the present invention. The database component 136 requires a plurality of tables, including a Cards Table 142, a Products Table 144, a Vendors Table 146, and an Employees Table 148 as shown in FIG. 11. Each of the tables maintains critical information for the system as a whole, and allows for tracking each pre-paid certificate throughout its lifecycle.

The Cards Table 142 includes a certificate identifier field for each issued certificate. The Cards Table 142 also includes a password field and a product identifier field to indicate what products a certificate represents. An active field indicates whether an issued certificate is valid for use. Certificates are invalid until they have been issued, and then only valid until they have been used. A vendor field indicates the vendor to whom each certificate has been issued. An issue date field indicates a date of issuance for each certificate. An issued by field indicates which employee(s) issued a particular certificate. A use date field indicates a date on which each certificate was used by a consumer. Also, a username field indicates the name of the consumer that used each certificate.

The Products Table 144 includes a product identifier field that includes a unique identifier for each product. The product description field includes a name and description of each product. The price field includes the price of each product.

The Vendor Table 146 includes a vendor identifier field that includes a unique identifier for each vendor. The vendor name field includes the names of all vendors. The cards issued field includes the quantity of certificates issued to a particular vendor. The certificates used field is populated by the quantity of certificates that have been used by the consumer. The discount rate field is populated the percentage of the value of each certificate that the vendor must pay.

The Employee Table 148 includes an employee identifier field, where an employee identifier is a unique identifier fore each employee, for example a login name. The employee name field includes the name of each employee. The password field is used for logging into the management system.

The interface components of the computer work include one for managing certificates and alphanumeric sequences, and one for consumers to reclaim certificates and sequences. Either the provider of the system or a third party can maintain these two interfaces. Additionally, the interfaces can be web-based or operated by any networked application.

The management interface 138 assigns and generates alphanumeric sequences, which include the certificate identifier and password pairs. The management interface 138 has the ability to re-assign used or invalidated sequences to certificates. Each certificate must also be assigned a product identifier from the product table of the database to represent what product each of the certificates can be redeemed for.

The management interface 138 also manages certificate distribution. This is used to create the vendors table in the database, and to issue certificates to the vendors, as well as activate certificates once they have been issued to vendors. Only certificates that have been issued to vendors are activated for use by a consumer. The number of certificates issued to vendors is also added to the certificates issued field of the vendor table in the database. Also, the employee identifier of the employee that issues certificates is to be entered in each cards record, for the purpose of tracking who is issuing certificates. Further, the date of issuance must also be added to each cards record. The certificate distribution aspect of the management interface also is capable of generating an invoice for each vendor setting the cost of the certificates to a vendor, using the formula (product price * quantity * vendor discount rate).

The management interface 138 also creates and manages the products provided by purchasing the certificates. The management interface 138 also assigns certificate identifiers and passwords to the products, provides product descriptions, and provides prices for each product that a certificate can represent.

The management interface 138 must also manage the authorized users of the management interface, such as employees. It must also be able to assign passwords, identifiers, and names for each authorized user or employee. The management interface can also generate a list of sequences and the product assigned to them at any time.

The user interface component 140 is used by the consumer to reclaim certificates for the product the certificate represents. Depending the alphanumeric sequence scheme used, it must allow the consumer to input the certificate identifier and password on the certificate they purchase for validation. If the inputted alphanumeric sequence does not match an activated certificate, the alphanumeric sequence is invalidated.

FIG. 6 is a flowchart of steps in the process of distributing access to content over the system of the present invention. Block 152 shows the step of providing a plurality of alphanumeric sequences. Block 154 shows the step of assigning a specified period of usage time and a level of content access for each alphanumeric sequence in the plurality of alphanumeric sequences. This function is performed by the management interface 138. Block 156 shows the step of storing the plurality of alphanumeric sequences in the database 136. These alphanumeric sequences are stored in the Cards Table 142 of the database 136.

Continuing with FIG. 6, block 158 shows the step authenticating an entered alphanumeric sequence. The system includes software for authenticating entered sequences. Block 160 shows the step of placing the consumer in a menu field showing accessible entertainment content. Once a consumer has entered an alphanumeric sequence, and that sequence has been authorized, the consumer is then directed to a menu field of the entertainment content he or she has been authorized to access. This menu field may correspond to that listed in the indicia on the face of the certificate 110, if such indicia is included with the consumer's certificate. Block 162 shows the step of allowing the consumer to access the level of content authorized by the entered alphanumeric sequence. At this stage, the system may also prompt the consumer to enter his or her age or date of birth for verification purposes.

While a consumer is accessing pre-paid content, the system monitors the consumer's usage of the system, as shown in block 164. The purpose is to calculate the remaining usage time available for each of the alphanumeric sequences. Block 166 shows the step of calculating time remaining. Once a consumer's access time expires, the system prohibits the consumer from any further access using the entered alphanumeric sequence as shown in block 168. Once a period of time usage expires, the database 136 is updated as shown in block 170 to indicate that the corresponding alphanumeric sequence has been fully redeemed and is no longer valid.

The access certificate 110 and its assigned alphanumeric sequence 112 permits access to a menu of different content forums within the location, or web site 150, specifically indicated on the certificate. Preview of content forums in short descriptive narrative provide the consumer with an immediate choice of selection of content forums. The monetary value on the certificate provides the consumer with a choice of a plurality of content forums and free services. The consumer has the option of selecting and purchasing certificates with different monetary values, which increase or decrease the number of content forums that are accessible.

FIG. 7 is a general flowchart of the overall steps in providing pre-paid content to consumers over a computer network. Block 174 shows the step of providing an access certificate 110, having an alphanumeric sequence 112. Block 176 shows the step of providing an indication of a time period available with the certificate. Block 178 shows the step of providing an indication of a specific location or web site 150 where the time period can be redeemed. Block 180 shows the step of providing a menu selection of the content available at the web site 150. Block 182 shows the step of providing the certificate for purchase prior to accessing the content.

Access time is determined by the monetary value of each certificate 110 purchased by the consumer. The access time is non-rechargeable: for example, certificates 110 having an access time period of one (1) calendar month means access for 30 consecutive days. It should be noted that access time can be provided either for a period of calendar days, or for a specified period of time, such as for example 10 hours. Upon accessing the specified web site 150 by entering the alphanumeric sequence 112 at the user interface 140, the software component of the system identifies the alphanumeric sequence 112 and automatically provides the consumer with multiple menu selection upon authentication of the alphanumeric sequence. Upon the consumer's initial access and selection of a forum, the software generates a decreasing point value for the consumer, which in one example is for one calendar month. The consumer cannot re-generate or recharge for additional time; instead a new access certificate must be pre-purchased prior to accessing specified content.

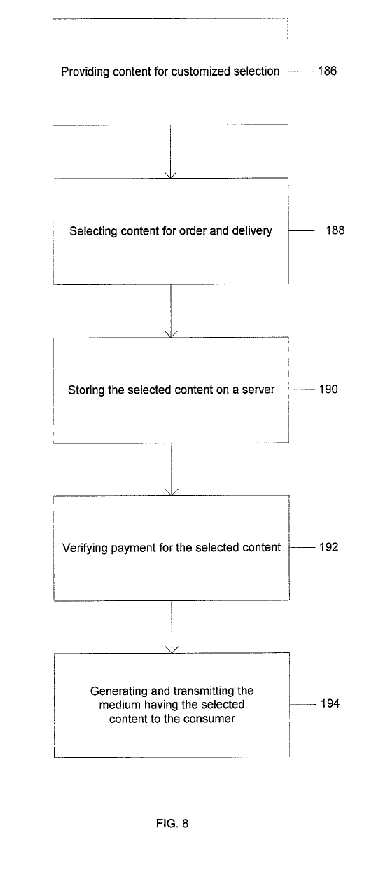

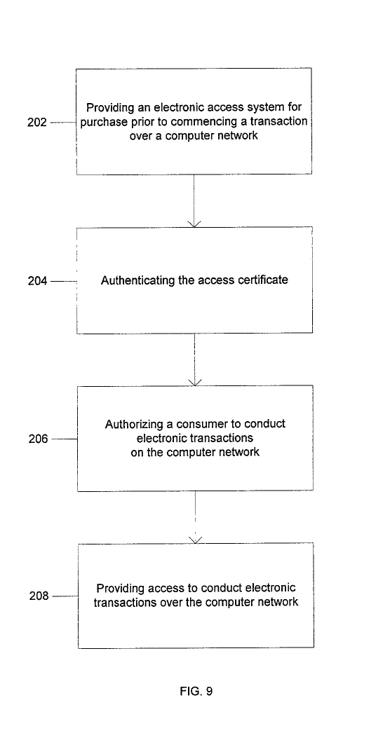

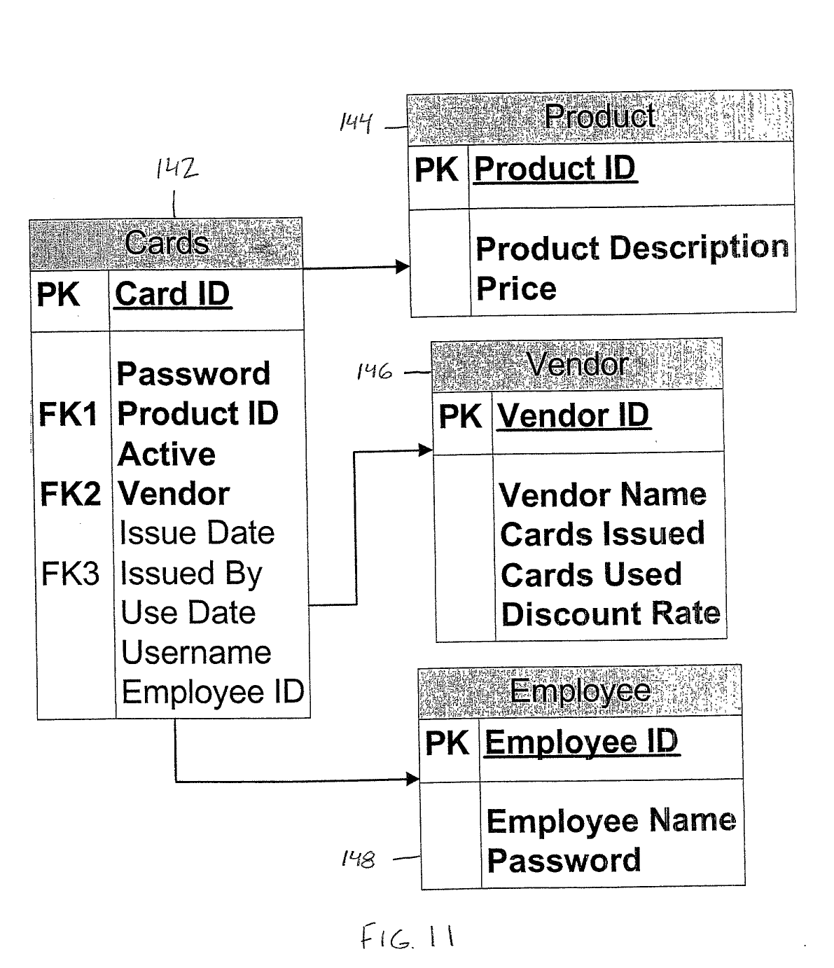

FIG. 8 and FIG. 10 are a flowchart and block diagram representation of one embodiment of the present invention, in which a consumer has the option of selecting accessed content for copying and delivery on a particular type of media. The present invention allows a consumer to select content accessed by the certificate to be copied and provided to the consumer either electronically over the computer network, or on some physical medium, such as a compact disc. For example, features, photos, video and digitized movies, music and other content that the consumer desires is selected and edited by the consumer. User friendly instructions on how to save content is readily made available in each content forum. By merely clicking on a “Save for CD” instruction button, the system stores the content in a location unique to the alphanumeric access code of the consumer. The system has the capacity to hold single or multiple audio and video or digitized movies in length of several hours, and numerous photographic or graphic images as well as text. The consumer has the additional option of editing materials that have been Saved by either deleting or adding new material. Dependent upon the monetary value of the certificate, certain consumer may be entitled to free media containing their selected content.

In FIG.8, which is a flowchart showing steps in the process of generating customized media, block 186 shows the step of providing content for customized selection. In this step, a consumer enters a valid alphanumeric sequence having the certificate identifier and the password as discussed above. Block 188 shows the step of selecting entertainment content for order and delivery on a medium. The medium may be tangible or electronic. Block 190 shows the step of storing the selected content on the server 134. After content is selected, the system stores the selected content on the server for subsequent transfer to the medium.

Block 192 shows the step of verifying the payment of the consumer. Under certain circumstances, based upon the amount the consumer has pre-paid for access to the content, the consumer may be given selected content for free on the medium of his or her choice. Under other circumstances, the consumer may be required to enter a personal credit card number for payment before selected content will be delivered. Block 194 shows the step of generating the medium for transmittal to the consumer.

The media used for delivery on content may be in the form of compact disc (CD/CD-ROM), video CD, digital video disc (DVD), electronic download, or any other type of media onto which content can be placed. For ease of discussion, this specification will refer to the compact disc, or CD, as a default media type.

FIG. 10 is a block diagram of a database system showing a plurality of tables storing information needed for generating media having selected content in this embodiment of the present invention. Block 196 shows the CDPics Table. The first step in generating a CD is to select objects. While viewing objects on a web site, the consumer selects objects to add to a CD. The relative paths to the object and its representative thumbnail image are entered into the CDPics Table 196. The consumer is redirected to a personal “My CD Page.” This page displays all previously selected objects and the remaining number of objects allowed on the consumer's CD. The consumer then selects “Make CD” and is redirected to a “Purchase CD Page.” The consumer's CD credit and level of access are checked to generate the appropriate price for the CD to be purchased. After the consumer has supplied the appropriate purchase information, and his or her credit card is approved, if necessary, each entry for that consumer in the CDPics Table is updated and an entry is made in the Order Table 210.

Once an order for a “My CD” has been placed, the management system software generates a CD. A temporary directory structure is created to represent the CD. Using the CDPics Table, all CD objects are copied to their proper place in the directory structure. A generic “Front Page” is copied to the directory structure. A gallery page is generated for each of the appropriate directories of content, such as movies and pictures. The directory structure is then copied to the CD.

After these steps have been completed, the CD is tested. If the test fails, the above steps are repeated. If the test is positive, the selections are removed the CDPics Table, and the CD is shipped to the consumer using the consumer's purchase information.

The system components of the CD selection and generation system include a web site 150, a database 136, and software for enabling object selection and media generation. The web site is the end-user's interface for selecting CD objects. The site includes a viewing page for viewing pictures and movies. Consumers are given the option of adding these pictures or movies to their individual “My CD Page.” At this page, consumers can view or remove CD objects that have been added to their accounts. Each object on the page corresponds to an entry in the CDPics Table. The web site also includes the appropriate pages for purchasing the CD.

The database component of the My CD system requires the use of at least three tables: CDPics, Users, and Orders. Each of these tables maintains critical information for the system as a whole, and allows for tracking each “My CD” throughout its lifecycle.

The CDPics Table 196 has several fields. The Username filed identifies each user entry, and relates to the Users Table. Another field, Path, defines the relative path to the CD object selected. Another field, Thumb Path, defines the relative path to the thumbnail image that represents each CD object. The Movie field indicates whether an entry is for a movie or a picture. An indication of true indicates the entry is a movie, while an indication of false indicates the entry is a picture. The Date Added field indicates the date that each entry was made. The Status field indicates the current status of each entry. Entries with a status of “W” indicate that they are waiting to be copied.

The Users Table 198 also includes fields, such as the Username field, which includes a unique identifier for each user. The CD credit field indicates a number of discount credits each consumer has towards purchasing CDs.

The Orders Table 200 also has several fields. The Invoice field is a unique identifier for each order. The Product ID field indicates and item being ordered. The Quantity field indicates the number of items being ordered. The Username field indicates the name of the person ordering the item. The Billing Info field includes payment information of a consumer, such as credit card billing address. The Shipping Info field includes information such as the address to which a product will be shipped.

The software component is responsible for the creation of media and for clearing the CDPics Table 196 after CDs have been created. The software is located either on the server or on a separate computer provided the computer has certain components, such as physical hardware to write data to CDs, access to the same database used by the web site, a copy of the directory structure containing the CD objects on the web site, and sufficient disk drive capacity to the create a temporary directory for CD creation.

The software requests the username of the consumer, the path to the CD Object directory structure, and the path to the temporary CD directory structure. Using this information, the software retrieves the records from the CDPics Table that represents the CD Objects selected by the consumers. The information contained in these records allows the software to copy the CD Objects and their representative thumbnail images to the appropriate directories in the temporary CD directory structure. These files are renamed when they are copied using a simplified naming scheme. A generic “Front Page” is copied into the root of the directory structure. This “Front Page” contains links to the web site and each of the local galleries located on the CD. Two gallery pages, one each for movies and pictures, are generated using the thumbnail images located in the temporary directory structure.

This temporary directory structure is then copied to a CD. This CD is then tested. If the CD fails, another copy is attempted. If it passes, the entries for that consumer are removed from the CDPics Table and the CD is shipped to the appropriate shipping address.

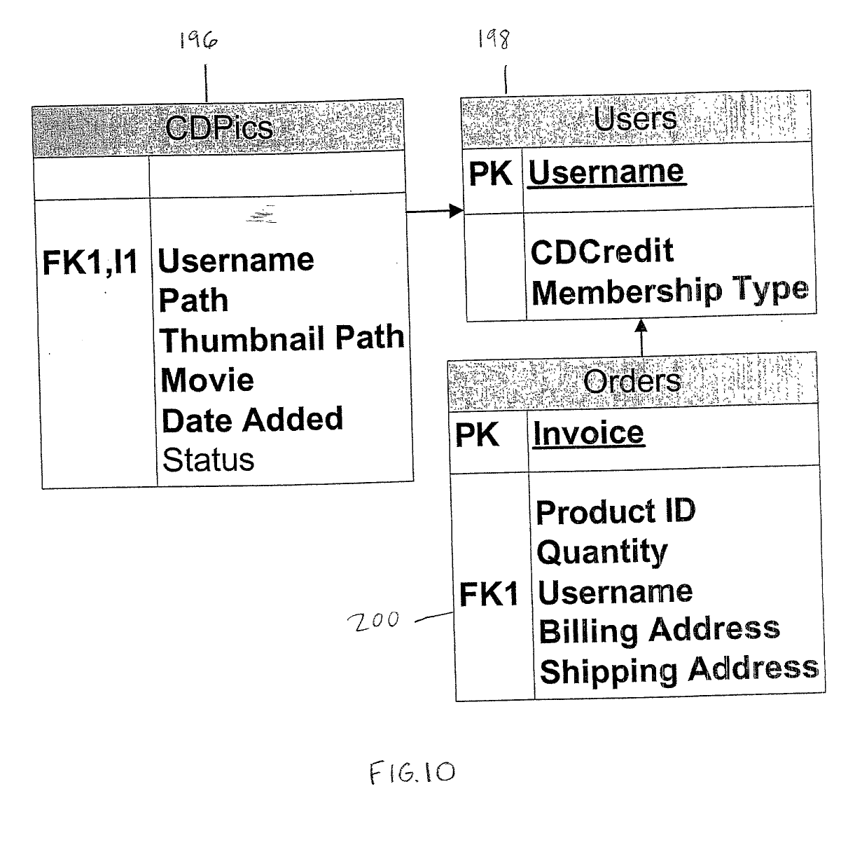

FIG. 9 is a flowchart representation of another embodiment of the present invention, in which a system and method of reducing fraud in electronic sales transactions is provided. In this embodiment of the present invention, the risk of fraud and non-payment is reduced for both the buyer and seller using the system and method of pre-paid electronic access.

Block 202 shows the step of providing an electronic access system. A consumer may purchase the electronic access system, which may take the form of a physical or a virtual certificate, such as electronic data, prior to commencing a business transaction on a computer network. As above, the certificate 110 includes an alphanumeric sequence 112 having a certificate identifier component 114 and a password component 116. Block 204 shows the step of authenticating the access system. Using system components discussed above in FIG. 5, the system determines whether a consumer is permitted to conduct his or her business transaction using the electronic access system by checking his or her alphanumeric sequence against a list of issued alphanumeric sequences. Block 206 shows the step of authorizing a consumer's access to content. After presenting an authenticated alphanumeric sequence, the system of this embodiment of the present invention authorizes the consumer to conduct business transactions on the computer network. Block 208 then shows the step of providing access to at least one location where business transactions can be completed using the pre-paid electronic access system.

From a seller's perspective, often transactions are risky due to the fact the seller and buyer may not know each other, or have an established relationship a common occurrence in international business. With the present invention, the buyer prepays for access to the seller's goods. This way, the seller's risk of nonpayment of the buyer is reduced considerably, allowing the seller to freely contract with the buyer to provide his goods and services. This results in lowered transactions costs as well.

From the buyer's perspective, a buyer in an electronic sales transaction is often afraid to submit credit card information and other private information over a computer network, for fear of this information being stolen. This results in fewer electronic sales transactions. Using the present invention, the buyer can prepay under safer and more secure circumstances for access to a seller. The buyer can then take the certificate of sale, or card or voucher, to a seller's location on the computer network, and redeem his or her pre-paid certificate for goods and services, with the certificate being debited until all pre-paid funds are exhausted.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, many different mediums can be used to embody the access certificate of the present invention, such as a physical card similar to a credit card, or on an electric medium such as data file sent via e-mail. Also, the access certificates can be conformed for redemption in several different time periods, such as over a particular calendar month, or for a specified number of hours. It is therefore intended that the scope of the invention be limited not by this detailed description.

In the claims:

1. A system for distributing access to materials on a network, comprising:
a plurality of alphanumeric sequences each including a password component and a certificate identifier component; and
a network including:
a server storing content for at least one specific location on the network where a period of usage time can be redeemed with at least one of the plurality of alphanumeric sequences, the server allowing a consumer to access the at least one specific location when at least one of the plurality of alphanumeric sequences is presented to the network, wherein the consumer pays for the at least one of the plurality of alphanumeric sequences before obtaining access to the content at the least one specific location;
a database for storing a list of the plurality of alphanumeric sequences, wherein the database includes a plurality of tables for monitoring the plurality of alphanumeric sequences;
a management interface for generating the plurality of alphanumeric sequences and assigning a product identifier component to each one of the plurality of alphanumeric sequences; and
an user interface for entering the at least one of the plurality of alphanumeric sequences and obtaining access to the content.

2. The system of claim 1, wherein a period of usage time is assigned to each of the plurality of alphanumeric sequences.

3. The system of claim 1, wherein one of the plurality of tables in the database is a certificate identifier table.

4. The system of claim 1, wherein one of the plurality of tables in the database is a product identifier table.

5. The system of claim 1, wherein one of the plurality of tables in the database is a vendor identifier table.

6. The system of claim 1, wherein one of the plurality of tables in the database is an employee identifier table.

7. The system of claim 1, wherein the plurality of alphanumeric sequences are validated by checking an entered alphanumeric sequence against the list of the plurality of alphanumeric sequences stored in the database.

8. The system of claim 7, wherein the consumer is allowed to access the entertainment content authorized by the entered alphanumeric sequence.

9. The system of claim 8, wherein the consumer is placed in a menu field showing the content accessible by the entered alphanumeric sequence, after the entered alphanumeric sequence is validated by the network.

10. The system of claim 2, wherein the server continually monitors a consumer's access to the content authorized by the entered alphanumeric sequence.

11. The system of claim 10, wherein the server calculates a remaining usage time available for each entered alphanumeric sequence.

12. The system of claim 11, wherein the server prohibits access to the content upon expiration of the period of usage time assigned to the entered alphanumeric sequence.

13. The system of claim 12, wherein the database is updated to indicate that the entered alphanumeric sequence has been fully redeemed and is no longer valid.

14. The system of claim 1, wherein the server allows access to a plurality of specific locations for consumers presenting authenticated certificate identifiers and passwords.

15. The system of claim 1, wherein an alphanumeric sequence in the plurality of alphanumeric sequences is embodied in a card.

16. The system of claim 1, wherein an alphanumeric sequence in the plurality of alphanumeric sequences is embodied in an electronic certificate.

17. The system of claim 16, wherein the electronic certificate is a series of data forming an electronic file transmittable to the consumer over the network.

18. The system of claim 1, wherein the network verifies the consumer's age before allowing access to the content.

19. A system for generating customized media, comprising:
a database for storing content data and a plurality of alphanumeric sequences;
an user interface for selecting content on a computer network, the user interface allowing a consumer to present at least one of the plurality of alphanumeric sequences for accessing the content on the computer network; and
a server for routing the selected content to a management interface, and wherein the management interface generates media onto which selected content is transferred and delivers the media to the consumer.

20. The system of claim 19, wherein the plurality of alphanumeric sequences each include a password component and a certificate identifier component.

21. The system of claim 19, further comprising a network for permitting communication between the server, the database, the management interface, and the user interface.

22. The system of claim 21, wherein the server stores the content for at least one specific location on the network where a period of usage time can be redeemed with at least one of the plurality of alphanumeric sequences, the server allowing the consumer to access the at least one specific location when the at least one of the plurality of alphanumeric sequences is presented to the network, and wherein the consumer pays for the at least one of the plurality of alphanumeric sequences before obtaining access to the content at the least one specific location.

23. The system of claim 22, wherein the management interface generates the plurality of alphanumeric sequences and assigns a product identifier component to each one of the plurality of alphanumeric sequences.

24. The system of claim 23, wherein the database stores a list of the plurality of alphanumeric sequences, and wherein the database includes a plurality of tables for monitoring the plurality of alphanumeric sequences.

25. The system of claim 24, wherein the plurality of tables in the database includes an objects table for storing product selection information.

26. The system of claim 24, wherein the plurality of tables in the database includes an users table for storing user information.

27. The system of claim 24, wherein the plurality of tables in the database includes an orders table for storing order information.

28. A method of distributing access to content over a computer network, comprising:
providing a plurality of alphanumeric sequences, each alphanumeric sequence in the plurality of alphanumeric sequences having a certificate identifier component and a password component;
assigning a specified amount of usage time and a level of content access for each alphanumeric sequence in the plurality of alphanumeric sequences;
storing the plurality of alphanumeric sequences in a database;
indicating to a consumer, on a computer network over a user interface, a choice of entering a personal credit card number or an alphanumeric sequence to obtain access to a level of content;
authenticating an entered alphanumeric sequence by validating the entered alphanumeric sequence against the stored plurality of alphanumeric sequences in the database;
allowing the consumer to access the level of content authorized by the entered alphanumeric sequence; and
placing the consumer in a menu field showing content accessible by the entered alphanumeric sequence.

29. The method of claim 28, further comprising continually monitoring the consumer's access to the level of content authorized by the entered alphanumeric sequence.

30. The method of claim 29, further comprising calculating a remaining amount usage time available for each entered alphanumeric sequence.

31. The method of claim 30, further comprising prohibiting access to the content upon expiration of an amount of usage time assigned to the entered alphanumeric sequence.

32. The method of claim 31, further comprising updating the database to indicate that an alphanumeric sequence has been fully redeemed and is no longer valid.

33. The method of claim 28, further comprising providing a server for maintaining at least one specific electronic address and for storing content at the at least one specific electronic address available to be accessed by a consumer.

34. The method of claim 28, further comprising allowing access to a plurality of specific locations for consumers presenting authenticated certificate identifiers and authenticated passwords.

35. The method of claim 28, wherein the database includes a plurality of tables for monitoring the plurality of alphanumeric sequences.

36. The method of claim 28, further comprising providing a certificate including an alphanumeric sequence to a consumer, wherein the certificate is a series of data forming an electronic file transmittable to the consumer over a computer network.

37. The method of claim 36, further comprising providing the certificate for purchase by the consumer prior to accessing the content over the computer network, wherein the consumer enters the certificate identifier and the password provided on the certificate when accessing the content.

38. The method of claim 28, further comprising verifying a consumer's age before allowing access to the content.

39. A method for generating customized media, comprising:
providing content for customized selection by a consumer entering a valid alphanumeric sequence having at least a certificate identifier component and a password component;
selecting content for order and delivery on a medium;
storing the selected content on a server;
verifying payment for the selected content; and
generating the medium and transmitting the medium to the consumer.

40. The method of claim 39, wherein the medium is an electronic transmission of data over a computer network.

41. The method of claim 39, wherein the medium is a CD-ROM.

42. The method of claim 39, wherein the medium is a DVD.

43. The method of claim 39, wherein the alphanumeric sequence entered by the consumer indicates whether payment is required for selected content.

44. The method of claim 43, further comprising entering payment information if the alphanumeric sequence entered indicates that selected content must be paid for.

45. The method of claim 44, further comprising indicating to a consumer, on a computer network over a user interface, a choice of entering a personal credit card number or an alphanumeric sequence to obtain access to a level of content.

46. The method of claim 39, further comprising verifying a consumer's age before allowing access to the content.

47. The method of claim 39, further comprising assigning a specified amount of usage time and a level of content access for the alphanumeric sequence.

48. The method of claim 39, further comprising providing a plurality of alphanumeric sequences each having a certificate identifier and a password.

49. The method of claim 48, further comprising assigning a specified amount of usage time and a level of content access for each of the plurality of alphanumeric sequences.

50. The method of claim 49, further comprising storing the alphanumeric sequences in a database.

51. The method of claim 50, further comprising providing a user interface to facilitate entry of an alphanumeric sequence by a consumer.

52. The method of claim 51, further comprising authenticating an entered alphanumeric sequence by validating the entered alphanumeric sequence against a list of the alphanumeric sequence stored in the database.

53. The method of claim 52, further comprising placing the consumer in a menu field showing entertainment content accessible by the entered alphanumeric sequence.

54. The method of claim 53, further comprising allowing the consumer access the level of content authorized by the entered alphanumeric sequence.
